(19) United States
(12) Patent Application Publication
(10) Pub. No.: US 2019/0255540 A1
(43) Pub. Date: Aug. 22, 2019

(54) STRIP COOLING APPARATUS

(71) Applicant: PRIMETALS TECHNOLOGIES USA LLC, Alpharetta, GA (US)

(72) Inventors: JOHN G. STEDGE, Chalfont, PA (US); William T. Larsen, Lexington, MA (US)

(73) Assignee: PRIMETALS TECHNOLOGIES USA LLC, Alpharetta, GA (US)

(21) Appl. No.: 16/032,534

(22) Filed: Jul. 11, 2018

Related U.S. Application Data
(60) Provisional application No. 62/631,667, filed on Feb. 17, 2018.

(51) Int. Cl. B05B 1/06; B05B 12/08

(52) U.S. Cl. CPC B05B 1/06; B05B 11/0002; B05B 12/087

(57) ABSTRACT

A cooling system is provided includes a target material and a plenum or header structure. A plurality of nozzle structures is coupled to the plenum or header structure that provides a uniform flow stream from each nozzle structure. The nozzle structure are angled away from the center of the target material as well as being angled in the direction of travel of the target material so as to improve cooling uniformity by providing independent fluid paths from each of the nozzle structures to the edge of the target material reducing the interaction of fluid streams from adjacent nozzle structures.

### PRIORITY INFORMATION

This application claims priority from provisional application Ser. No. 62/631,667 filed Feb. 17, 2018, which is incorporated herein by reference in its entirety.

### BACKGROUND OF THE INVENTION

The invention is related to the field of cooling systems, and in particular to strip cooling apparatus.

Most conventional cooling systems use convection, so the cooling fluid must be directed to impinge on the work. The cooling rate per unit of surface area is a function of the temperature of the target material, the temperature of the cooling fluid and the heat transfer coefficient at their common boundary. Common methods for directing the cooling fluid include holes or slots cut in plenums which face the work. Pipe or box headers may also be used in place of the plenums. These apparatuses are easy to fabricate but cannot achieve higher heat transfer coefficients without significant increases in supplied fluid energy as well as a resulting instability (flutter) in the work. Pipe nozzles have been used to increase fluid velocity at the boundary for a given fluid energy, thereby improving heat transfer coefficients.

The most recent design enhancement for which prior art exists where work instability (flutter) is reduced by angling pipe nozzles away from the centerline of the work. This reduces the stochasticity of the fluid flow by providing a more uniform flow path for the fluid after impingement thus limiting time-variance of the aerodynamic forces on the work.

### SUMMARY OF THE INVENTION

According to one aspect of the invention, there is provided a cooling system. The cooling system includes a target material and a plenum or header structure. A plurality of nozzle structures are coupled to the plenum or header structure that provides a uniform flow stream from each nozzle structure. The nozzle structures are angled away from the center of the target material as well as being angled in the direction of travel of the target material so as to improve cooling uniformity by providing independent fluid paths from each of the nozzle structures to the edge of the target material reducing the interaction of fluid streams from adjacent nozzle structures.

According to another aspect of the invention, there is provided a method for performing the operation of a cooling system. The method includes providing a target material and providing a plenum or header structure. Also, the method includes positioning a plurality of nozzle structures that are coupled to the plenum or header structure that provides a uniform flow stream from each nozzle structure. The nozzle structure are angled away from the center of the target material as well as being angled in the direction of travel of the target material so as to improve cooling uniformity by providing independent fluid paths from each of the nozzle structures to the edge of the target material reducing the interaction of fluid streams from adjacent nozzle structures.

### BRIEF DESCRIPTION OF THE DRAWINGS

FIGS. 1A-1B are schematic diagrams illustrating an embodiment of the invention that utilizes a nozzle with a reduced cross-section;

FIGS. 2A-2B are schematic diagrams illustrating an embodiment of the invention that utilizes angled nozzles; and

FIG. 3 is a schematic diagram illustrating am embodiment of the invention with tapered, angled nozzles.

### DETAILED DESCRIPTION OF THE INVENTION

The invention describes a nozzle design for reducing cross-section at discharge and providing for a uniform flow stream from each nozzle, regardless of the dynamics of the fluid flow within the plenum or header arrangement. In addition to being angled (laterally) away from the center of the target material, the nozzles are angled (longitudinally) in the direction of travel of the target material or away from the direction of travel. This feature improves cooling uniformity by providing independent fluid paths from each nozzle to the edge of the work thereby reducing the interaction (mixing) of fluid streams from adjacent nozzles.

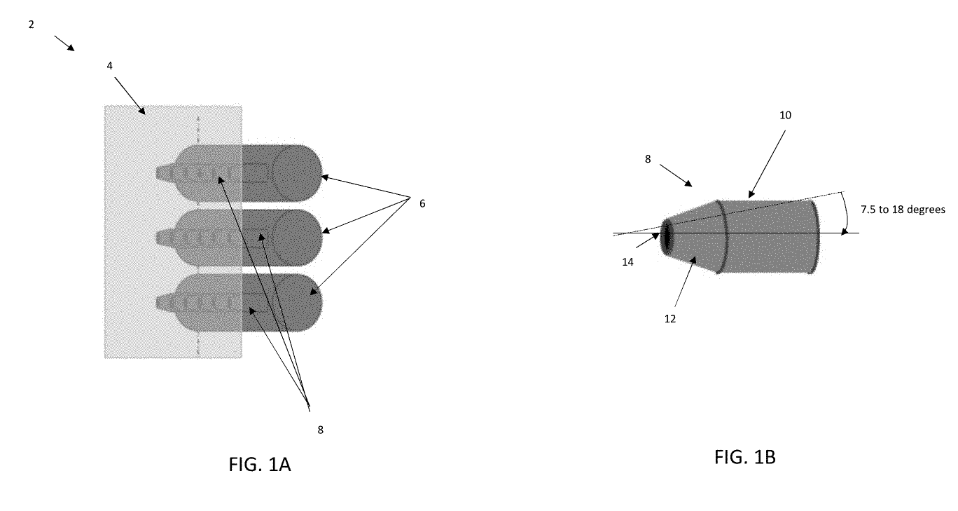

FIGS. 1A-1B are schematic diagrams illustrating an embodiment of the invention that utilizes a nozzle with a reduced cross-section. The arrangement 2 includes a number of tapered nozzle structures 8 formed from a plenum or header 6, as shown in FIG. 1A. The tapered nozzle structures 8 have a reduced cross section at discharge. This allows for a uniform flow stream from each tapered nozzle 8, regardless of dynamics of the fluid flow within a plenum or header 6 to the target material 4. FIG. 1B shows a detailed view of the tapered nozzle 8 having a first tapered cylindrical portion 12 positioned on a cylindrical body 10. The bottom portion of the cylindrical body 10 can be connected to the plenum or header 6. The tapered portion 12 is tapered with an opening 14 to allow the uniform flow stream of fluid to exit onto the target material 4. For this embodiment, the opening 14 is approximately 25 mm diameter at the tip, but in other embodiments of the invention the opening can have a diameter between 10 mm and 30 mm. These are typically based on standard pipe or tube sizes for the larger portion of the nozzle. Regardless of the size, the taper angle will stay similar with an optimum taper angle of 12.5 degrees. In other embodiments of the invention the taper angle can be between 7.5 and 18 degrees.

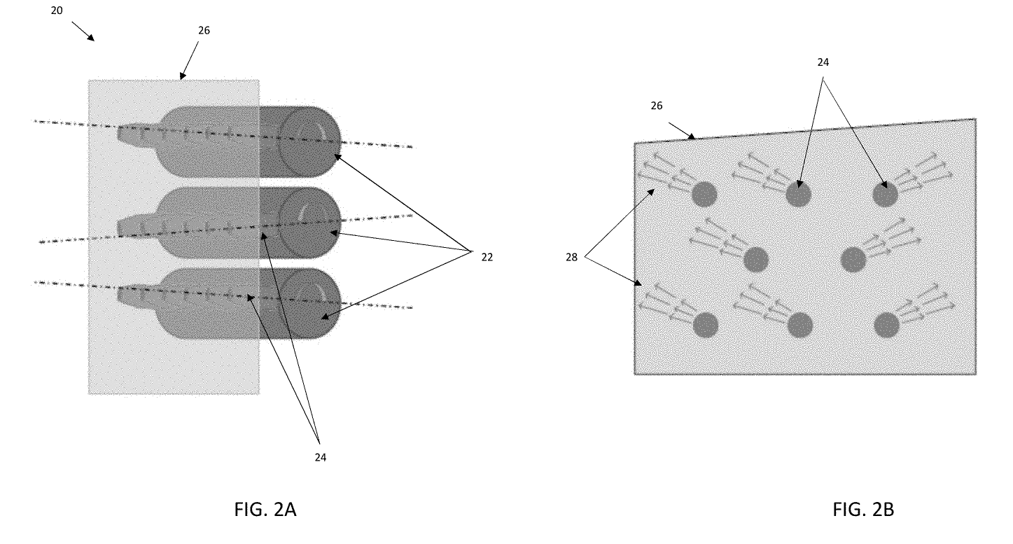

FIGS. 2A-2B are schematic diagrams illustrating an embodiment of the invention that utilizes angled nozzles. The arrangement 20 includes a number of angled nozzle structures 24, as shown in FIG. 2A. In addition to being angled laterally away from the center of the target material 26, the nozzles 24 are angled longitudinally in the direction of travel or away from the direction of travel of the target material 26, as shown in FIG. 2A. This feature improves cooling uniformity by providing independent fluid paths 28 from each nozzle 24 to the edge of the target material thereby reducing the interaction of fluid streams from adjacent nozzles, as shown in FIG. 2B. The nozzles are generally angled in two directions. The nozzles 24 are angled away from the centerline of the target material 26. For this embodiment, the longitudinal angle is 15 degrees from vertical. The optimal longitudinal angle is 2 degrees and a typical range of 0.5-5 degrees from perpendicular can be used in other embodiments of the invention.

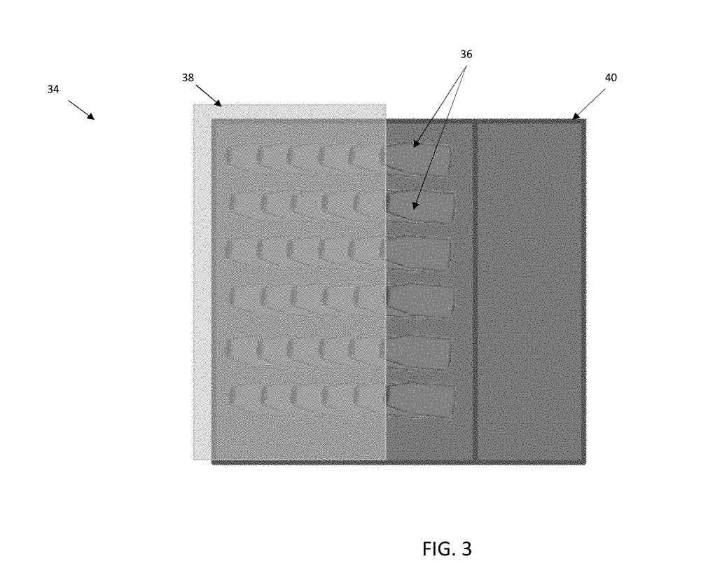

FIG. 3 is a schematic diagram illustrating an embodiment of the invention with tapered, angled nozzles. The arrangement 34 includes a plenum 40 with a number of tapered, angled nozzles 36. The tapered, angled nozzles 36 of this arrangement combines the tapered nozzle of FIG. 1A and the angled nozzle of FIG. 2A into a nozzle structure 34 that is both tapered and angled. The advantages includes a uniform flow stream from each tapered, angled nozzle 36, regardless of dynamics of the fluid flow within a plenum or header 40 to the target material 38. In addition, this arrangement 34 improves cooling uniformity by providing independent fluid paths from each tapered, angled nozzle 36 to the edge of the target material 38 thereby reducing the interaction of fluid streams from adjacent nozzles. Note the tapered angle and longitudinal angle used here have similar angular properties described for both the tapered nozzles and tapered, angled nozzles described herein. The advantage of the taper at the end of the nozzle is reduced pressure drop through the nozzle for a given cooling rate and the associated power reduction required to pressurize the cooling fluid.

The invention provide a novel nozzle design for reducing cross-section at discharge while providing for a uniform flow stream from each nozzle. This occurs regardless of the dynamics of the fluid flow within the plenum or header arrangement. The novel nozzle design includes nozzle structures that are angled (laterally) away from the center of the target material as well as being angled (longitudinally) in the direction of travel of the target material. This approach increases cooling uniformity by allowing for independent fluid paths from each nozzle to the edge of the work thereby reducing the interaction (mixing) of fluid streams from adjacent nozzles.

Although the present invention has been shown and described with respect to several preferred embodiments thereof, various changes, omissions and additions to the form and detail thereof, may be made therein, without departing from the spirit and scope of the invention.

What is claimed is:

1. A cooling system comprising:
a target material;
a plenum or header structure; and
a plurality of nozzle structures coupled to the plenum or header structure that provides a uniform flow stream from each nozzle structure, wherein the nozzle structure are angled away from the center of the target material as well as being angled in the direction of travel or away from the direction of travel of the target material so as to improve cooling uniformity by providing independent fluid paths from each of the nozzle structures to the edge of the target material reducing the interaction of fluid streams from adjacent nozzle structures.

2. The cooling system of claim 1, wherein the angle in the direction of travel or away from the direction of travel is defined by a longitudinal angle of the target material comprises a longitudinal angle between 0.5 and 5 degrees.

3. The cooling system of claim 1, wherein each of the nozzle structures comprises a tapered nozzle structure.

4. The cooling system of claim 1, wherein each of the nozzle structures comprises an angled nozzle structure.

5. The cooling system of claim 1, wherein each of the nozzle structures comprises an tapered, angled nozzle structure.

6. The cooling system of claim 3, wherein the tapered nozzle structure comprises a tapered portion that is coupled to cylindrical portion.

7. The cooling system of claim 6, wherein the tapered nozzle structure comprises a tapered angle between 7.5 degrees and 18 degrees

8. The cooling system of claim 5, wherein the angled nozzle structure is angled at two different directions.

9. The cooling system of claim 8, wherein the nozzle structures are positioned away from the centerline of the target material.

10. The cooling system of claim 9, wherein the angled nozzle structure comprises a longitudinal angle between 0.5 degrees and 5 degrees.

11. A method for performing the operation of a cooling system comprising:
providing a target material;
providing a plenum or header structure; and
positioning a plurality of nozzle structures that are coupled to the plenum or header structure that provides a uniform flow stream from each nozzle structure, wherein the nozzle structure are angled away from the center of the target material as well as being angled in the direction of travel or away from the direction of travel of the target material so as to improve cooling uniformity by providing independent fluid paths from each of the nozzle structures to the edge of the target material reducing the interaction of fluid streams from adjacent nozzle structures.

12. The method of claim 11, wherein the angle in the direction of travel of the target material comprises a longitudinal angle between 0.5 and 5 degrees.

13. The method of claim 11, wherein each of the nozzle structures comprises a tapered nozzle structure.

14. The method of claim 11, wherein each of the nozzle structures comprises an angled nozzle structure.

15. The method of claim 11, wherein each of the nozzle structures comprises an tapered, angled nozzle structure.

16. The method of claim 13, wherein the tapered nozzle structure comprises a tapered portion that is coupled to cylindrical portion.

17. The method of claim 16, wherein the tapered nozzle structure comprises a tapered angle between 7.5 degrees and 18 degrees

18. The method of claim 15, wherein the angled nozzle structure is angled in two different directions.

19. The method of claim 18, wherein the nozzle structures are positioned away from the centerline of the target material.

20. The method of claim 19, wherein the angled nozzle structure comprises a longitudinal angle between 0.5 degrees and 5 degrees.
